(19) United States
(12) Patent Application Publication
(10) Pub. No.: US 2018/0130445 A1
(43) Pub. Date: May 10, 2018

(54) DYNAMIC INTERIOR COLOR PALETTE

(71) Applicant: Faraday&Future Inc., Gardena, CA (US)

(72) Inventor: Nicholas William Dazé, Los Angeles, CA (US)

(21) Appl. No.: 15/656,312

(22) Filed: Jul. 21, 2017

Related U.S. Application Data
(60) Provisional application No. 62/365,491, filed on Jul. 22, 2016.

(51) Int. Cl. G09G 5/06; B60R 1/00; B60Q 3/80

(52) U.S. Cl. CPC G09G 5/06; B60R 1/00; B60Q 3/80; B60R 2300/302; B60R 2300/50; B60R 2300/108; G09G 2320/0666

(57) ABSTRACT

An interior color control system for a vehicle including a sensor configured to capture an image of a scene exterior to the vehicle, a display with configurable color, and a controller in communication with the sensor and interior display. The controller may be configured to determine a first set of color features based on the captured image, and a second set of color features based on the first set of color features, for the interior display.

### CROSS-REFERENCE TO RELATED APPLICATIONS

This application claims the benefit of U.S. Provisional Application No. 62/365,491, filed Jul. 22, 2016, the entirety of which is hereby incorporated by reference.

### TECHNICAL FIELD

The present disclosure relates generally to environment control inside a vehicle, and more particularly to color control of displays and luminaries in a vehicle based on captured exterior images.

### BACKGROUND

Modern vehicles house multiple interior displays and luminaries with different functions. They are used as user interfaces, entertainment stations, communication devices, or simply light sources. Perceived colors of displays, and their combination with exterior elements, have an important impact on one's attention and state of mind. Conventional methods enable vehicle passengers to manually manipulate certain parameters of these light sources and displays. For example, passengers might manipulate the intensity of the interior light or select ‘themes’ with a predefined color palette in their displays. In some systems, the displays and luminaries properties might be related to external lighting conditions. For example, the brightness of interior panels can be increased when vehicle is under bright sun to enhance contrast.

Although conventional methods may be suitable for some applications, they are still less than optimal and fail to take advantage of recently developed hardware and software capabilities to create a more pleasant user experience. Specifically, current interior lighting systems do not take into account the environment surrounding the vehicle to manipulate the interior light parameters. The conventional color adjusting features have a limited ability to manipulate colors and they typically rely on user adjustments or predefined setups.

The color control system of the present disclosure is directed to mitigate or solve the above described and/or other problems in the art.

### SUMMARY

One aspect of the present disclosure is directed to an interior color control system for a vehicle. The system may include a sensor configured to capture an image of a scene exterior to the vehicle, a display with configurable color, and a controller in communication with the sensor and interior display. The controller may be configured to determine a first set of color features based on the captured image, and a second set of color features for the interior display based on the first set of color features.

Another aspect of the present disclosure is directed to a method for controlling the interior colors of a vehicle. The method may include capturing an image of a scene exterior to the vehicle, determining a first set of color features based on the captured image, and determining a second set of color features for the interior display based on the first set of color features.

Yet another aspect of the present disclosure is directed to a non-transitory computer-readable storage medium storing a computer program which, when executed by at least one processor, causes the at least one processor to perform a method of controlling the interior color of a vehicle. The stored method may include capturing an image of a scene exterior to the vehicle, determining a first set of color features based on the captured image; and determining a second set of color features for the interior display based on the first set of color features.

### BRIEF DESCRIPTION OF THE DRAWINGS

FIG. 1. is a perspective illustration of an exemplary interior color control system for a vehicle, according to a disclosed embodiment.

FIG. 2. is a diagrammatic illustration of an exterior of an exemplary vehicle, according to a disclosed embodiment.

FIG. 3 is a block diagram illustrating an exemplary environment network including an interior color control system, according to a disclosed embodiment.

FIG. 4. is a flowchart illustrating an exemplary process for controlling interior color inside a vehicle, according to a disclosed embodiment.

FIG. 5. is a flowchart illustrating an exemplary process for determining interior color features based on exterior color features, according to a disclosed embodiment.

### DETAILED DESCRIPTION

The disclosed interior color control system may enable color adjustments of displays and luminaries in the interior of a vehicle based on the exterior scenery to improve user experience. The system may use information that is communicated to a controller from sensors such as cameras, radars, and LIDARs, to determine a first set of color features. The controller utilizes the exterior information to determine a second set of color features. Then, the color of displays and lighting devices may be adjusted with a color palette that is generated based on the second set of color features. The disclosed system may also utilize other information, such as location, landscape features, or time of the day to determine the second set of color features. The system may also be utilized to adjust color features of other user interfaces within the vehicle, such as displays on mobile devices carried into the vehicle.

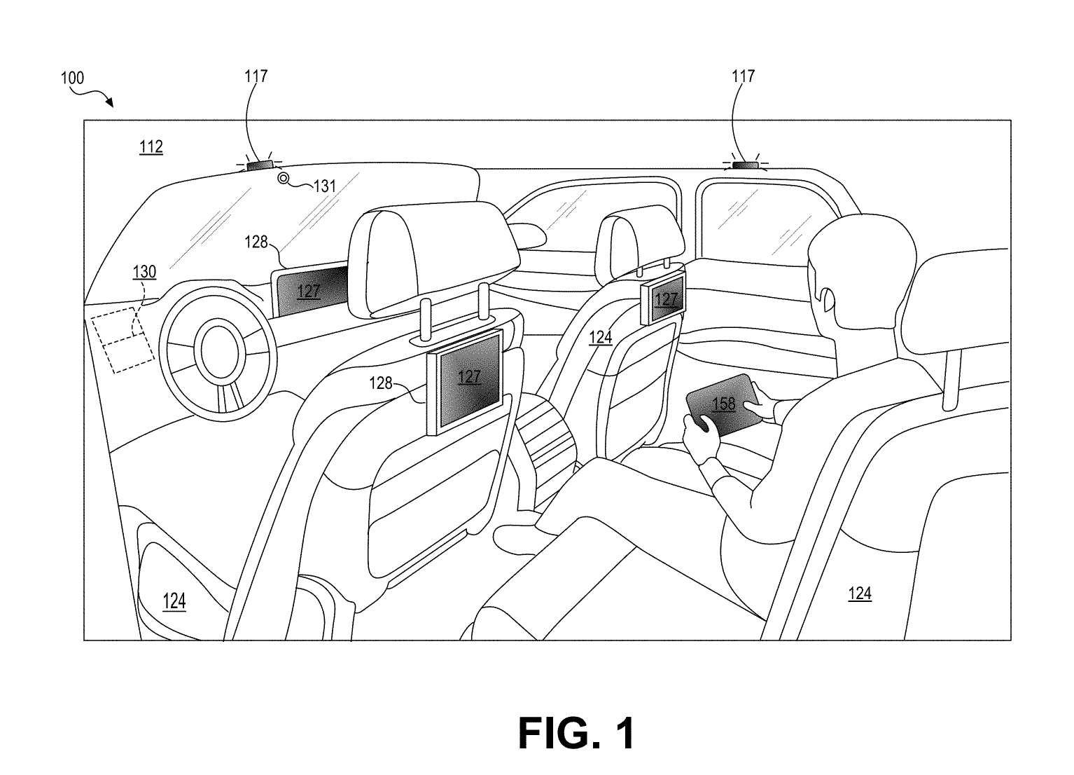

FIG. 1 is a diagrammatic illustration of an exemplary system 100 for controlling the interior color features of an exemplary vehicle 112. Vehicle 112 may have any body style, such as a sports car, a coupe, a sedan, a pick-up truck, a station wagon, a sports utility vehicle (SUV), a minivan, a conversion van, a bus, or a commercial truck. Vehicle 112 may be an electric vehicle, a fuel cell vehicle, a hybrid vehicle, or a conventional internal combustion engine vehicle. Vehicle 112 may be configured to be operated by a driver occupying vehicle 112, to be remotely controlled, and/or to be autonomously controlled. As illustrated in FIG. 1, vehicle 112 may further include a plurality of seats 124 to accommodate occupants of the vehicle.

System 100 may include vehicle displays 127, mobile device displays 158, and interior luminaries 117; System 100 may further include other components, such as interior cameras 131, exterior cameras 212, a radar or LIDAR 216, a controller 130, and user interfaces 128.

Vehicle displays 127, mobile devices 158, and interior luminaries 117 may display color features according to a configurable color palette that is determined by controller 130. Controller 130 is connected to the displays and luminaries with wired or wireless methods, e.g., via communication cables, wired or wireless networks such as radio waves, a nationwide cellular network, and/or a local wireless network (e.g., Bluetooth′ or WiFi), or other communication methods.

Additionally, user interface 128 may be configured to accept input or commands from vehicle occupants. For example, user interface 128 may also provide a graphical user interface (GUI) presented on the display 127 for user input, and may be configured to send user input to controller 130.

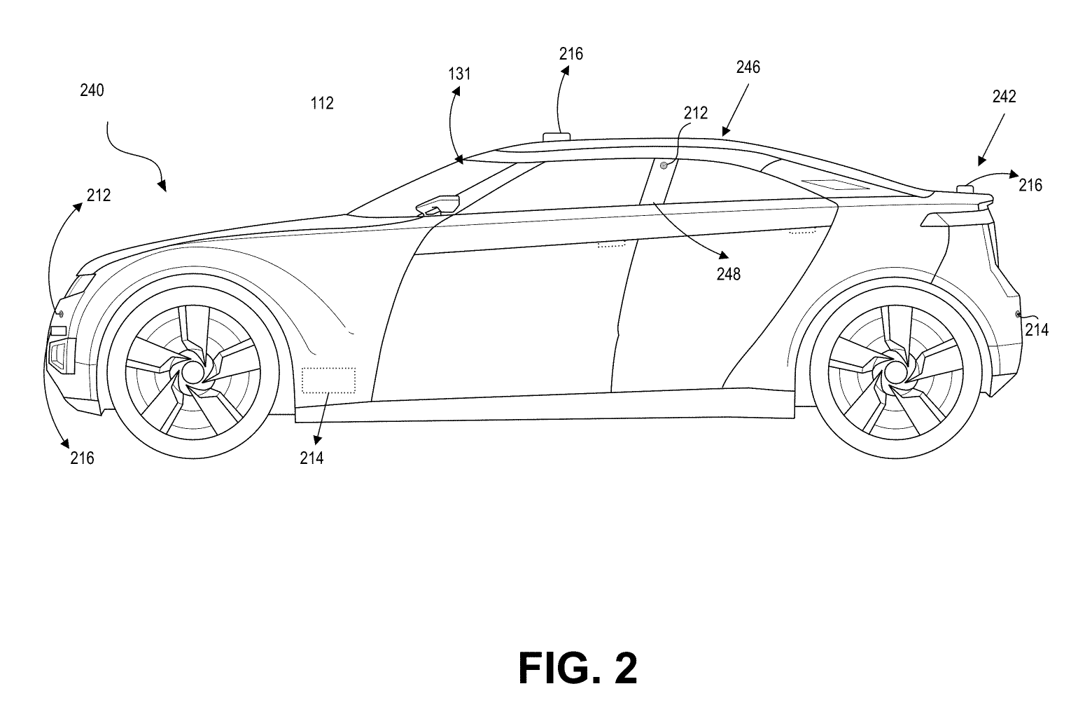

Controller 130 may also be connected to exterior sensors presented in FIG. 2, which provides a diagrammatic illustration of the exterior of an exemplary vehicle 112. As illustrated in FIG. 2, vehicle 112 may include a frame having a front end 240, a rear end 242, a celling 246, and a plurality of pillars 248 on each side of vehicle 112. Vehicle 112 may also include exterior sensors such as cameras 212 and/or electromagnetic surveying devices such as radars and/or LIDARs 216. Vehicle 112 may further include positioning devices such as a GPS receiver 214, connected to controller 130. Exterior sensors and positioning devices may be embedded on vehicle 112 or attached to panels with, for example, bolts and fasteners.

In some embodiments, the exterior cameras 212 may be positioned in multiple parts of the vehicle including front end 240, rear end 242, ceiling 246, and side pillars 248. Similarly, the electromagnetic surveying devices could be positioned in multiple parts of the vehicle 112. All these exterior elements may be also connected to the controller with wired or wireless methods and may be powered with the vehicle's main battery, independent batteries, RF-based wireless charging, or RF energy harvesting devices.

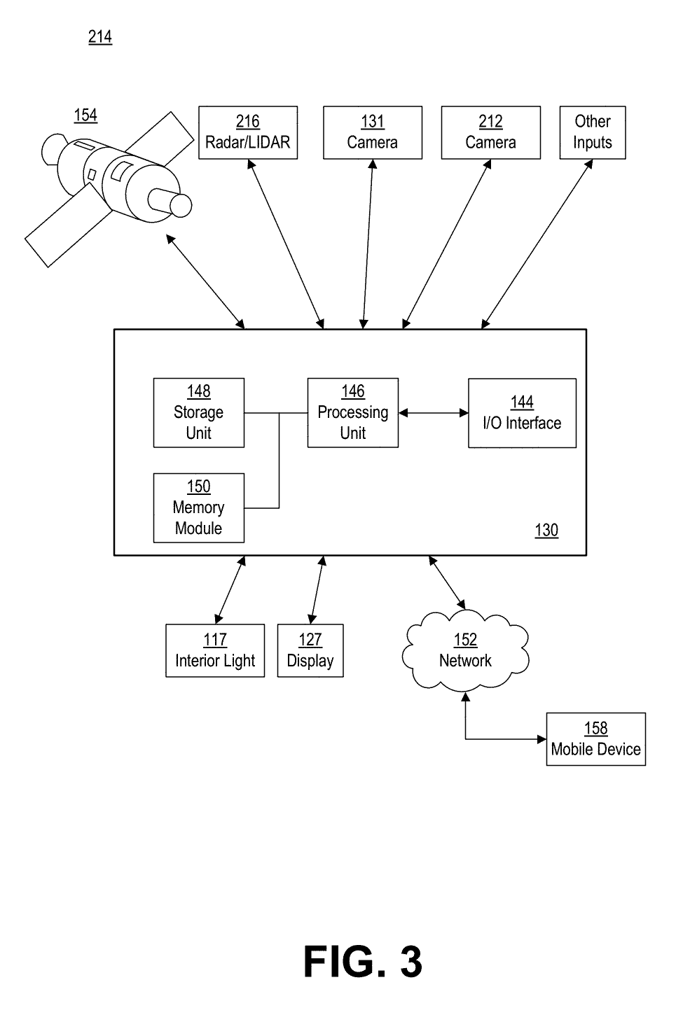

Controller 130 is illustrated in greater detail in FIG. 3. This figure provides a block diagram of a network, including controller 130, that may be used with an exemplary system for determining a second set of color features based on a first set of color features perceived by sensors. Controller 130 may include I/O interface 144, processing unit 146, storage unit 148 and memory module 150. Controller 130 may have different modules in a single device, such as a processor or FPGA, or separated devices with dedicated functions.

I/O interface 144 may send and receive data between components such as user interface 128, interior camera 131, exterior camera 212, surveying devices 216, location devices 214, and controller 130 via communication cables, wireless networks such as radio waves, a nationwide cellular network, and/or a local wireless network (e.g., Bluetooth′ or WiFi), or other communication methods.

Controller 130 may further include processing unit 146, which may be configured to generate and transmit command signals via I/O interface 144. Processing unit 146 may be configured to determine a first set of color features based information received from exterior sensors. Processing unit 146 may also be configured to calculate a second set of color features based on the received information from sensors pertaining the exterior scenery. Processing unit 146 may also be used to generate color palettes and codify instructions to modify color features of displays and luminaries. In some embodiments, processing unit 146 may receive a command from user interface 128. Such command may include selection of particular color features or a location preference.

Processing unit 146 may also receive input from other components of system 100, vehicle 112, and from other sources. As shown in FIG. 3, controller 130 may be configured to receive data from multiple sources including the radar/LIDAR sensors 216, interior cameras 131, exterior cameras 212, mobile device 158, and other inputs in vehicle 112, such as speakers and microphones. Controller 130 may also be configured to receive vehicle location data, from positioning devices such as GPS or cellular networks, and using location methods such as image recognition. For example, satellite 154 may provide signals indicative of location data that may be received by the GPS unit 214.

Processing unit 146 may also be connected with wired or wireless methods to vehicle displays 127, mobile devices 158, and interior luminaries 117. The processing unit may be able to assign color features, update registries in displays microcontrollers, select emission frequencies, manipulate light intensity, and show patterns in the displays and luminaries inside the vehicle. In some exemplary embodiments the processing unit 146 may create master-slave hierarchies with microcontrollers of displays and luminaries to dominate the displayed features.

Controller 130 may also include storage unit 148 and/or memory module 150, which may be configured to store one or more computer programs that may be executed by processing unit 146 to perform functions of system 100. For example, storage unit 148 and/or memory module 150 may be configured to store location preferences, dominant color extraction routines, color generation algorithms, or image processing software. Storage unit 148 and/or memory module 150 may also be configured to store color palettes and color display rules. For example, storage unit 148 and/or memory module 150 may be configured to store user preferences pertaining to passengers related to vehicle 112. Storage unit 148 and/or memory module 150 may also store software related to facial or voice recognition.

One or more components of controller 130 may be located locally in vehicle 112, as shown, or may alternatively in a mobile device 158, in a user interface 128, in the cloud, or another remote location. Components of controller 130 may be in an integrated device, or distributed at different locations but communicate with each other through network. For example, processing unit 146 may be a processor on-board vehicle 112, a processor inside mobile device 158, or a cloud processor.

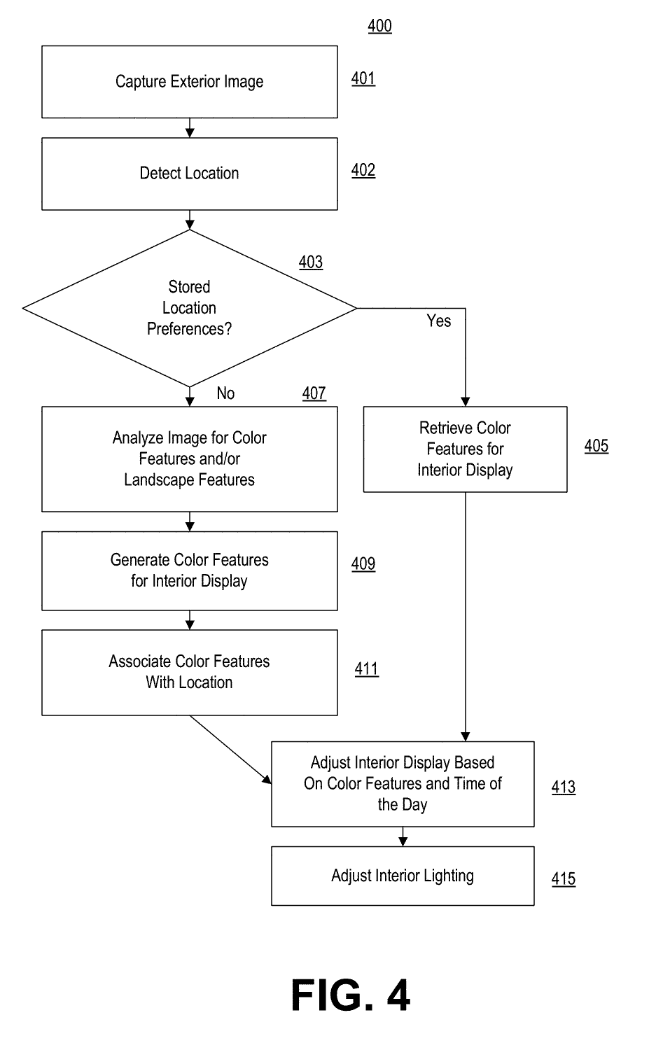

FIG. 4 is a flowchart illustrating an exemplary process 400 for controlling the interior color features based on the captured surrounding scenery. In step 401, sensors may be triggered to capture images and other information about a scene exterior to the vehicle. The data, such as 2D, 3D images, coded maps, or multi-dimensional matrixes of the scene, may be then transmitted to controller 130 through wired or wireless networks. Controller 130 may, continually or intermittently, request the exterior image from sensors based on defined rules stored in the storage unit 148 or preferences set through user interface 128.

In Step 403, positioning devices or methods may be used to detect the location of the vehicle. In one embodiment, the GPS unit 214 may calculate the vehicle location based on information received from satellites 154 and communicate it to controller 130. In other embodiments, the captured exterior image may be processed using image recognition algorithms that correlate the captured images with information in storage unit 148 to identify the location. Alternatively, the captured exterior image might be communicated to image search engines to retrieve a location. Controller 130 may, continually or intermittently, request location updates of vehicle 112. For example, the scene captured in the image may include a landmark, which can be uniquely recognized and located.

In Step 403, controller 130 may request location preferences from memory module 150 or storage unit 148. If there are location preferences, predefined by the manufacturer or introduced by the vehicle user via user interface 128 or other I/O devices, controller 130 then retrieves color features for vehicle displays 127, interior luminaries 117, and mobile displays 158 in step 405. For example, a user might have correlated a specific location with a user defined color setting. Then, in step 405 controller 130 may retrieve the color setting when the vehicle is near the specific location. If there are not location preferences then process 400 continues to step 407.

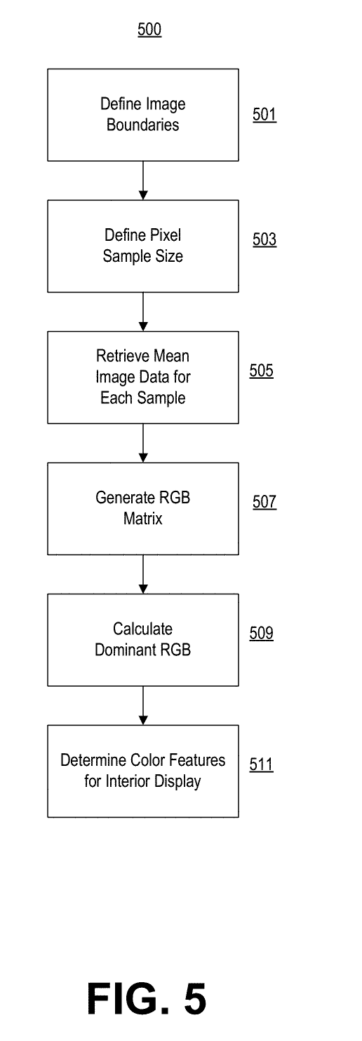

In step 407, controller 130 may analyze the captured exterior image and retrieve color and/or landscape features from the image using various image processing methods, an example of which is described below in connection with FIG. 5. Retrieved color features may include predominant colors present in the surrounding scenery. For example, if vehicle 112 is moving through a forest, the color features of the captured scenery will be green and brown from the prevalent trees. But if vehicle 112 is moving through a snow-covered landscape, color features might be white and blue. Additionally, retrieved landscape features may include predominant shapes and periodicity of distinct characteristics. For example, if vehicle 112 is moving through a city, it may retrieve buildings and post lights as landscape features. If vehicle 112 is moving through a rural landscape, it may retrieve crop lines and hills as the landscape features. Once the image is analyzed and features are extracted, a first set of color features is defined and stored. Controller 130 may use this first set of color features to generate a second set of color features in step 409. Color features may be generated to complement, match, or contrast exterior color features based on rules stored in memory unit 150.

In step 411, controller 130 may use the location information collected and saved in step 402 to associate the generated color features for interior display with the current location. The user might be asked to store the location preferences in memory unit 150 through user interface 128. In this step, the user may select to neglect or store location preferences via user interface 128. Additionally, the user might modify the color selections via user interface 128.

Whether the color features of interior display are defined based on stored location preferences or the generated color features, in step 413, controller 130 may detect the time of the day to select display parameters. For example, the controller may use the luminosity detected with cameras 131 and define the brightness of displays and luminaries in the vehicle. In another embodiment, the controller might match location and time to define current time of the day and adjust display parameters accordingly. For example, if controller 130 detects that it is night time it may decrease brightness of internal displays. Additionally, if controller 130 detects that it is day time, it may update its color selection to be warmer tones.

In step 415, controller 130 may communicate with vehicle displays 127, mobile displays 158, or interior luminaries 117 to adjust the color of interior color of the vehicle. Controller 130 may send instructions to update the microcontroller registries, change the emission frequency, or adjust the intensity of the luminary by adjusting the power supply output. In other embodiments, the controller may send instructions to adjust other lighting parameters within the vehicle such as light intensity, flashing patterns, or dynamic color changes. For example, controller 130 may control a multi-color dimmer to adjust the lighting parameters.

FIG. 5 is a flowchart illustrating an exemplary process 500 for determining interior color features based on exterior color features, according to a disclosed embodiment. Process 500 may start with a boundary definition step 501, where at least one image is constrained or cropped between specific boundaries. The boundaries of the image might be set in number of pixels in a coordinated axis or other length measurement. The controller will then define a pixel sample size. The sample size may be a function of the controller processing power, the rate of color updates, the quantity of collected exterior images, among others. For example, if the rate of control updates is high, e.g. less than a minute, the selected sample size may be small to improve the computing time. However, if the control update rate is low, every acquired pixel could be independently analyzed for greater precision. In step 505, the mean image data for each of the defined pixel samples is retrieved with functions that translates digital information from image files such as JPEG, PNG, or TIFF into numeric matrixes of two or more dimensions. For example, the retrieved image data may contain a mean of the RGB vectors for each one of the pixel samples in the collected image. Table 1 presents an example of a vector related to each sample with RGB information. Each color component could be defined with a three element vector as it is defined by the arithmetic RGB notation exemplified in Table 1.

TABLE 1

| RGB | | |
|---|---|---|
| Triplet | Short Name | Long Name |
| [1 1 0] | y | yellow |
| [1 0 1] | m | magenta |
| [0 1 1] | c | cyan |
| [1 0 0] | r | red |
| [0 1 0] | g | green |
| [0 0 1] | b | blue |
| [1 1 1] | w | white |
| [0 0 0] | k | black |

Averaging each one of the coefficients in the RGB vector will result in a combined color with partial coefficients and a resulting dominating color. In other embodiments, other color notations may be utilized to analyze each sampled pixel and include other features outside color. For example, other elements in the array can be used to indicate intensity, transparency, or image patterns. Furthermore, color information may be also correlated with complementing metrics such as analog intensity coming from a radar or depth information detected with LIDAR systems. Additionally, controller 130 may apply data filtering and enhancing methods to data from sensors to improve accuracy, comply with user preferences, or accelerate processes.

The retrieved image data of step 505 is then processed to generate an aggregated RGB or collected info matrix in step 507. This matrix contains information of all the sampled pixels and it is used to calculate the dominant features of captured images. For example, the RGB triplet of each sample may be averaged to identify a dominant color in step 509. It is contemplated that other statistical operations, such as mode or medium calculation, can also be used to calculate the dominant features such as RBG. In step 509, other parameters different from color might be take into consideration to establish color dominance. For example, calculation of step 509 may incorporate information from other sensors such as depth and intensity.

In step 511, controller 130 will generate a set of color features for the interior display, which can be used in step 409 of FIG. 4. In some embodiments, based on the calculated dominant RGB, controller 130 may select a color or a group of colors that complement, match, or contrast the retrieved first set of color features. Different methods based on color theory and the color wheel may be used to generate sets of color features. For example, controller 130 may generate complementary color features by selecting a color that is opposite to the dominant color in the color wheel. Also, controller 130 may generate a matching color palette by selecting two or more adjacent colors to the dominant color in the color wheel. Further, controller 130 may generate triadic and split-complementary color palettes by selecting two colors different from the dominant color based on rules defined in storage unit 148 or memory module 150. Additionally, controller 130 may generate second color features by selecting tetradic or square color palettes centered in the calculated dominant color. Other embodiments, may generate the second set of color features based on color classifications, such as warm/cool colors, and incorporate tints, shades, or tones for a greater design flexibility.

In step 511, controller 130 may generate sets of color features for the interior display. For example, controller 130 may replicate periodicity of scenery color features in the generated set by defining patterns of colors. Additionally, controller 130 may adjust variables such as saturation, luminance, or fading based on the landscape features, user preferences, or rules stored in storage unit 148 or memory module 150. For example, if vehicle 112 is driving in a sunset, controller 130 may generate degraded colors of different intensities in displays and luminaries.

Another aspect of the disclosure is directed to a non-transitory computer-readable medium computer-readable medium storing instructions which, when executed, cause one or more processors to perform the methods, as discussed herein. The computer-readable medium may include volatile or non-volatile, magnetic, semiconductor, tape, optical, removable, non-removable, or other types of computer-readable medium or computer-readable storage devices. For example, the computer-readable medium may be the storage unit having the computer instructions stored thereon, as disclosed. In some embodiments, the computer-readable medium may be a disc or a flash drive having the computer instructions stored thereon.

It will be apparent to those skilled in the art that various modifications and variations may be made to the disclosed interior color control system. Other embodiments will be apparent to those skilled in the art from consideration of the specification and practice of the disclosed interior color control system. It is intended that the specification and examples be considered as exemplary only, with a true scope being indicated by the following claims and their equivalents.

What is claimed is:

1. An interior color control system for a vehicle, comprising at least:
a sensor configured to capture an image of a scene exterior to the vehicle;
an interior display with configurable color; and
a controller in communication with the sensor and interior display, and configured to:
determine a first set of color features based on the captured image; and
determine a second set of color features for the interior display based on the first set of color features.

2. The control system of claim 1, wherein the sensor device includes at least one of a radar, a LIDAR, and a camera.

3. The control system of claim 1, wherein the display device includes at least one of a vehicle display and a display of a mobile device inside the vehicle.

4. The control system of claim 1, wherein the controller is further configured to determine a location of the vehicle; and associate the second set of color features with the location.

5. The control system of claim 4, wherein the location is determined based on at least the captured image or a GPS signal.

6. The control system of claim 1, wherein the controller is configured to determine a color palette for the interior display based on the second set of color features.

7. The control system of claim 1, wherein the first set of color features includes dominant colors in the captured image.

8. The control system of claim 1, wherein the controller is further configured to adjust interior lighting of the vehicle based on the first set of color features.

9. The control system of claim 1, wherein the controller is further configured to adjust the second set of color features based on a time of a day.

10. The control system of claim 9, wherein the controller is further configured to determine a set of landscape features based on the captured image; and determine the second set of color features based additionally on the set of landscape features.

11. A method for controlling the interior color of a vehicle, comprising steps of:
capturing an image of a scene exterior to the vehicle;
determining a first set of color features based on the captured image; and
determining a second set of color features for the interior display based on the first set of color features.

12. The method of claim 11, wherein the image is captured with at least one of a radar, a LIDAR, and a camera.

13. The method of claim 11, wherein the second set of color features is used in at least one of a vehicle display and a display of a mobile device inside the vehicle.

14. The method of claim 11, further comprising steps of determining a location of the vehicle; and associate the second set of color features with the location.

15. The method of claim 11, further comprising steps of determining a color palette for the interior display based on the second set of color features.

16. The method of claim 11, wherein the first set of color features includes dominant colors in the captured image.

17. The method of claim 11, further comprising steps of adjusting interior lighting of the vehicle based on the first set of color features.

18. The method of claim 11, further comprising steps of adjusting the second set of color features based on a time of a day.

19. A non-transitory computer-readable storage medium storing a computer program which, when executed by at least one processor, causes the at least one processor to perform a method of controlling the interior color of a vehicle, the method comprising:
capturing an image of a scene exterior to the vehicle;
determining a first set of color features based on the captured image; and
determining a second set of color features for the interior display based on the first set of color features.

20. The non-transitory computer-readable media of claim 19, wherein the image is captured with at least one of a radar, a LIDAR, and a camera.
